(19) United States
(12) Patent Application Publication
(10) Pub. No.: US 2022/0309534 A1
(43) Pub. Date: Sep. 29, 2022

(54) INFORMATION PUSHING METHOD AND ELECTRONIC DEVICE UTILIZING METHOD

(71) Applicant: HONG FU JIN PRECISION INDUSTRY (WuHan) CO., LTD., Wuhan (CN)

(72) Inventor: HUI-PING JUAN, New Taipei (TW)

(21) Appl. No.: 17/281,684

(22) PCT Filed: May 25, 2020
(86) PCT No.: PCT/CN2020/092132

§ 371 Date: Mar. 31, 2021

(51) Int. Cl. G06Q 30/02; G06V 40/16

(52) U.S. Cl. CPC G06Q 30/0255; G06V 40/174; G06V 40/172

(57) ABSTRACT

In an information pushing method, a first facial image of a target user is acquired. First expression features of the first facial image are extracted. A first emotion is determined according to the first expression features. Candidate advertisement information is determined according to the first emotion. Historical emotions of the target user are obtained. Target advertising information is determined from the candidate advertising information according to the historical emotions and is pushed to the target user. A system for administering such method and device applying method are also disclosed.

### FIELD

The subject matter herein generally relates to data processing, specifically an information pushing method, an information pushing system, an electronic device, and a computer storage medium.

### BACKGROUND

Advertising information can be pushed to users via various software or platforms. However, the advertising information actually pushed is usually fixed, and is often not what users need, resulting in a low advertising effectiveness.

Therefore, improving the advertising effectiveness of pushed information is problematic.

### BRIEF DESCRIPTION OF THE DRAWINGS

FIG. 1 is a flowchart of an information pushing method provided in one embodiment of the present disclosure.

FIG. 2 is a block diagram of an information pushing system provided in one embodiment of the present disclosure.

FIG. 3 is a block diagram of an electronic device implementing the information pushing method in one embodiment of the present disclosure.

### DETAILED DESCRIPTION

The technical solutions in the embodiments of the present disclosure will be described clearly and completely in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure.

Unless defined otherwise, all technical and scientific terms used herein have the same meaning as commonly understood by one of ordinary skill in the art to which the present disclosure belongs. The terms used herein in the present disclosure are only for the purpose of describing specific embodiments, and are not intended to limit the present disclosure.

An information pushing method is provided in embodiments of the present disclosure. The information pushing method can be applied to an electronic device. The information pushing method can also be applied to a hardware environment composed of an electronic device and a server connected to the electronic device through a network, being executed by the server and the electronic device. The network can include, but is not limited to, a wide area network, a metropolitan area network, or a local area network.

The server may refer to a computer system that can provide services to other devices (such as the electronic device) in the network. A computer providing a File Transfer Protocol (FTP) service for external use can be called a server. In a narrow sense, “server” may refer to a certain high-performance computer that can provide services to the outside world through the network. Compared with ordinary personal computers, the server may has higher requirements in terms of stability, security, and performance. The server may be different from ordinary personal computers in term of central processing unit (CPU), Chipset, memory, disk system, network and other hardware.

The electronic device is a device that can automatically perform numerical calculation and/or information processing in accordance with pre-set or pre-stored instructions. Hardware of the electronic device may include, but is not limited to, a microprocessor, an application specific integrated circuit (ASIC), a field programmable gate array (FPGA), a digital processor (DSP), an embedded device, etc. The electronic device may also include a network device and/or a user equipment. The network device includes, but is not limited to, a single network device, a server group composed of multiple network devices, or a cloud composed of a large number of hosts or network devices based on cloud computing. Cloud computing is a type of distributed computing. A cloud may be a super virtual computer composed of a group of loosely coupled but distributed computer sets. The user equipment may include, but is not limited to, any computing device that can interact with a user through a keyboard, a mouse, a remote control, a touch panel, or a voice control device. For example, user equipment may be a personal computer, a tablet computer, a smart phone, or a personal digital assistant (PDA), etc.

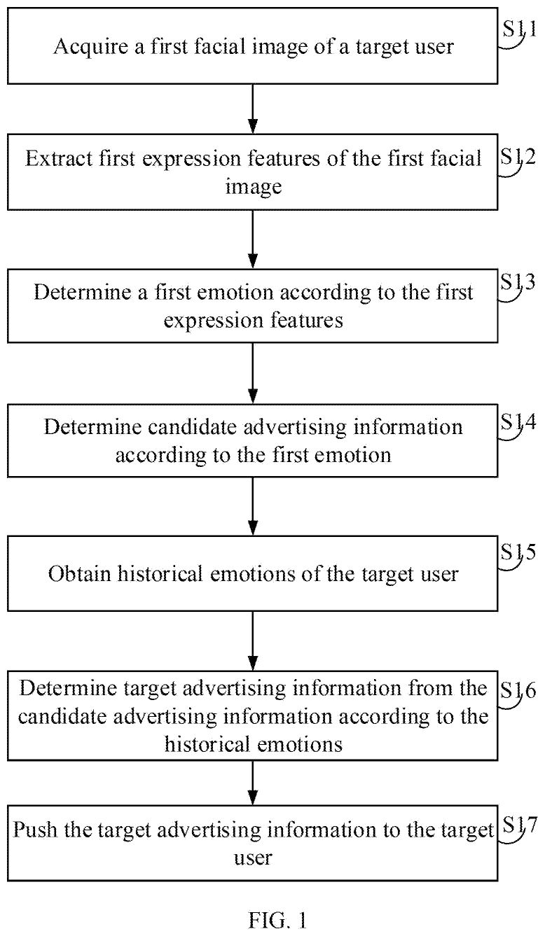

FIG. 1 is a flowchart of an information pushing method provided in one embodiment of the present disclosure. According to different requirements, the order of the steps in the flowchart may be changed, and some steps may be omitted. The information pushing method may be executed by an electronic device.

In block S11, a first facial image of a target user (that is, a user who has previously logged in to the device) is acquired.

The first facial image may be a current facial image of the target user.

In one embodiment, a desktop computer, a notebook computer, a tablet computer, a smart phone, or other image-capturing devices may be used to capture the first facial image of the target user.

Specifically, acquiring the first facial image of the target user may include: obtaining an image in real time; using a facial recognition technology to determine all registered users in the current image; determining whether there is a plurality of registered users in the current image; if there is one registered user in the current image, determining that the registered user is the target user; and determining the first facial image of the target user from the current image.

In the embodiment, the target user may register and upload his first facial image in advance. The target user can be recognized from the current image using a facial recognition technology. If there is only one registered user in the current image, it can be determined that the registered user is the target user.

In one embodiment, the information pushing method may further include: if there is a plurality of registered users in the current image, determining a usage time of each registered user in the current image; determining that a registered user with a longest usage time in the current image is the target user; and determining the first facial image of the target user from the current image.

In the embodiment, if there is a plurality of registered users in the current image, the usage time of each registered user can be obtained. The registered user with the longest usage time is determined to be the target user. The first facial image of the target user is determined from the current image.

In one embodiment, the information pushing method may further include: if there is a plurality of registered users, receiving a user selection instruction; determining a user indicated by the user selection instruction to be the target user; and determining the first facial image of the target user from the current image.

In the embodiment, the user selection instruction may be received by the electronic device, and the user indicated by the user selection instruction may be determined to be the target user. The first facial image of the target user may be determined from the current image.

In block S12, from the first facial image, first expression features are extracted.

In one embodiment of the present disclosure, the first facial image can be processed using image processing technologies to extract the first expression features. The first expression features of the first facial image can be extracted by an overall method and a partial method. The overall method may include, but not limited to, principal component analysis (PCA), independent component analysis (ICA) and linear discriminant analysis (LDA). The partial method may include, but is not limited to, a Gabor wavelet method and a local binary patterns (LBP) operator method.

In block S13, a first emotion is determined according to the first expression features.

The first emotion can include happy, excited, leisurely, tired, depressed, sad, angry, anxiety, and other emotions.

In one embodiment of the present disclosure, a relationship between first expression features and emotions can be established and stored in a database in advance. The first emotion corresponding to the first expression features can be quickly determined by querying the database.

In block S14, advertising information or content as candidate information (candidate advertising information) is determined according to the first emotion.

In one embodiment of the present disclosure, a relationship between candidate advertising information and emotions can be set in advance. Each emotion can correspond to multiple types of candidate advertising information, and each type of candidate advertising information can correspond to multiple emotions.

In block S15, emotions of the target user as historically recorded (historical emotions) are obtained.

The historical emotions are emotions of the target user related to advertising information. The historical emotions may include an emotion of the target user after the target user has viewed advertising information in the past, and an emotion of the target user after the target user uses a product introduced in advertising information in the past. The historical emotion can be stored in a data warehouse.

In block S16, target advertising information is determined from the candidate advertising information according to the historical emotions.

Specifically, the target advertising information can be determined from the candidate advertising information according to the historical emotions by: determining a target historical emotion according to the historical emotions; acquiring historical advertising information corresponding to the target historical emotion; determining product characteristics according to the historical advertising information; and determining the target advertising information that matches the product characteristics from the candidate advertising information.

The target historical emotion can be a positive emotion in the historical emotions. For example, the historical emotion can be excitement or happiness.

The product characteristics are used to describe products introduced in the historical advertising information. For example, products introduced in the historical information are home appliances, and prices of the products are between 100 RMB and 500 RMB. Therefore, the product characteristics may include a type of home appliance product and a price range of 100 RMB to 500 RMB.

In the embodiment, a positive emotion such as excitement or happiness can be determined to be the target historical emotion, and historical advertising information corresponding to the historical emotion is obtained. The product characteristics (such as product type, color, price range, etc.) of the historical advertising information are determined. The target advertising information matching the characteristic tags is determined from the candidate advertising information.

In block S17, the target advertising information is pushed to the target user.

In one embodiment of the present disclosure, the target advertising information can be output on the screen of the electronic device.

In one embodiment, after the target advertising information is pushed to the target user, the information pushing method may further include: acquiring a second facial image of the target user; extracting second expression features of the second facial image; determining a second emotion according to the second expression features; and adding the second emotion into the historical emotions of the target user.

The second facial image may be a facial image of the target user after the target advertising information is pushed to the target user.

In the embodiment, after the target advertising information is pushed to the target user, a second facial image of the target user is acquired, the second expression features of the second facial image are extracted. The second emotion is determined according to the second expression features. The second emotion is added into the historical emotions of the target user.

In the method flow described in FIG. 1, a user's emotion can be determined using facial recognition technology. Suitable advertising information is pushed to the user based on a current emotion and historical emotions. Effectiveness and timeliness of information pushing are improved.

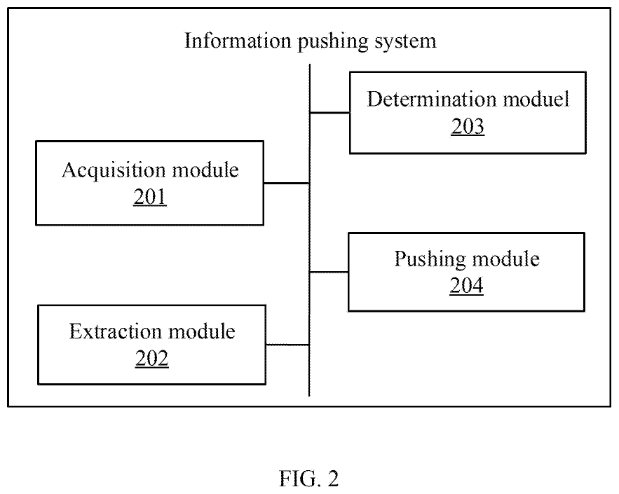

FIG. 2 is a block diagram of an information pushing system provided in one embodiment of the present disclosure.

In some embodiments, the information pushing system may run in an electronic device. The information pushing system may include a plurality of function modules consisting of program code segments. The program code of each program segment in the information pushing system may be stored in a storage device and executed by at least one processor to execute part or all of the steps in the information pushing system method described in FIG. 1.

In the embodiment, the information pushing system may be divided into a plurality of functional modules, according to the performed functions. The functional modules may include: an acquisition module 201, an extraction module 202, a determination module 203, and a push module 204. A module as referred to in the present disclosure refers to a series of computer-readable instruction segments that can be executed by at least one processor and that are capable of performing fixed functions, which are stored in a storage device.

The acquisition module 201 is configured to acquire a first facial image of a target user.

The first facial image may be a current facial image of the target user.

In one embodiment, a desktop computer, a notebook computer, a tablet computer, a smart phone, or other image-capturing devices may be used to capture the first facial image of the target user.

The extraction module 202 is configured to extract first expression features of the first facial image.

In one embodiment of the present disclosure, the first facial image can be processed using image processing technologies to extract the first expression features. The first expression features of the first facial image can be extracted by an overall method and a partial method. The overall method may include, but not limited to, principal component analysis (PCA), independent component analysis (ICA) and linear discriminant analysis (LDA). The partial method may include, but is not limited to, a Gabor wavelet method and a local binary patterns (LBP) operator method.

The determination module 203 is configured to determine a first emotion according to the first expression features.

The first emotion can be any one among happy, excited, leisurely, tired, depressed, sad, angry, anxiety and other emotions.

In one embodiment of the present disclosure, a relationship between first expression features and emotions can be established and stored in a database in advance. The first emotion corresponding to the first expression features can be quickly determined by querying the database.

The determination module 203 can determine candidate advertising information according to the first emotion.

In one embodiment of the present disclosure, a relationship between candidate advertising information and emotions can be set in advance. Each emotion can correspond to multiple items of candidate advertising information, and each item of candidate advertising information can correspond to multiple emotions.

The acquisition module 201 is further configured to obtain historical emotions of the target user.

The historical emotions are emotions of the target user related to advertising information. The historical emotions may include an emotion of the target user after the target user views advertising information in the past, and an emotion of the target user after the target user uses a product introduced in advertising information in the past. The historical emotion can be stored in a data warehouse.

The determination module 203 is further configured to determine target advertising information from the candidate advertising information according to the historical emotions.

The push module 204 is configured to push the target advertising information to the target user.

In one embodiment of the present disclosure, the target advertising information can be output on the screen of the electronic device.

In one embodiment, the determination module 203 may determine the target advertising information from the candidate advertising information according to the historical emotions by: determining a target historical emotion according to the historical emotions; acquiring historical advertising information corresponding to the target historical emotion; determining product characteristics according to the historical advertising information; and determining the target advertising information that matches the product characteristics from the candidate advertising information.

The target historical emotion can be a positive emotion in the historical emotions. For example, the historical emotion can be excitement or happiness.

The product characteristics are used to describe products introduced in the historical advertising information. For example, products introduced in the historical advertising information are home appliances, and prices of the products are between 100 RMB and 500 RMB. Therefore, the product characteristics may include a product type of home appliance and a price range of 100 RMB to 500 RMB.

In the embodiment, a positive emotion such as excitement or happiness can be determined to be the target historical emotion, and historical advertising information corresponding to the historical emotion is obtained. The product characteristics (such as product type, color, price range, etc.) of the historical advertising information are determined. The target advertising information matching the characteristic tags is determined from the candidate advertising information.

In one embodiment, the acquisition module 201 may acquire the first facial image of the target user by: obtaining a current image in real time; using a facial recognition technology to determine all registered users in the current image; determining whether there is a plurality of registered users in the current image; if there is one registered user in the current image, determining that the registered user is the target user; and determining the first facial image of the target user from the current image.

In the embodiment, the target user may register and upload his first facial image in advance. The registered user can be recognized from the current image using a facial recognition technology. If there is only one registered users in the current image, it can be determined that the registered user is the target user.

In one embodiment, the determination 203 is further configured to: determine a usage time of each registered user in the current image, if there is a plurality of registered users in the current image; determine that a registered user with a longest usage time in the current image is the target user; and determine the first facial image of the target user from the current image.

In the embodiment, if there is a plurality of registered users in the current image, the usage time of each registered user can be obtained. The registered user with the longest usage time is determined to be the target user. The first facial image of the target user is determined from the current image.

In one embodiment, the information pushing system may further include a receipt module. The receipt module is configured to receive a user selection instruction if there is a plurality of registered users. The determination 203 is further configured to determine a user indicated by the user selection instruction to be the target user; and determine the first facial image of the target user from the current image.

In the embodiment, the user selection instruction may be received by the electronic device, and the user indicated by the user selection instruction may be determined to be the target user. The first facial image of the target user may be determined from the current image.

In one embodiment, the acquisition module 201 is further configured to acquire a second facial image of the target user after the target advertising information is pushed to the target user. The extraction module 202 is further configured to extract second expression features of the second facial image. The determination module 203 is further configured to determine a second emotion according to the second expression features. The information pushing system is further include an addition module configured to add the second emotion into the historical emotions of the target user.

The second facial image may be a facial image of the target user after the target advertising information is pushed to the target user.

In the embodiment, after the target advertising information is pushed to the target user, a second facial image of the target user is acquired, the second expression features of the second facial image are extracted. The second emotion is determined according to the second expression features. The second emotion is added into the historical emotions of the target user.

In the information pushing system described in FIG. 2, a user's emotion can be determined using facial recognition technology. Proper advertising information is pushed to the user based on a current emotion and historical emotions. Effectiveness and timeliness of information pushing are improved.

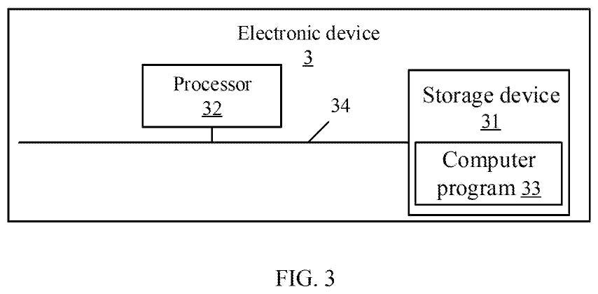

FIG. 3 is a block diagram of an electronic device implementing the information pushing method in one embodiment of the present disclosure. The electronic device 3 may include a storage device 31, at least one processor 32, a computer program 33 that is stored in the storage device 31 and run on the at least one processor 32, and at least one communication bus 34.

Those skilled in the art can understand that the schematic diagram shown in FIG. 3 is only an example of the electronic device 3, and does not constitute a limitation on the electronic device 3. It may include more or less components than those shown in the figure, or a combination. Certain components, or different components, for example, the electronic device 3 may also include input and output devices, network access devices, and so on.

The electronic device 3 also includes, but is not limited to, any electronic product that can interact with the user through a keyboard, a mouse, a remote control, a touch panel, or a voice control device, for example, a personal computer, a tablet computer, a smart phone, etc. Personal Digital Assistant (PDA), game consoles, Internet Protocol Television (IPTV), smart wearable devices, etc. The network where the electronic device 3 is located includes but is not limited to the Internet, a wide area network, a metropolitan area network, a local area network, a virtual private network (VPN), etc.

The processor 32 may be a central processing unit (CPU) or other general-purpose processor, a digital signal processor (DSP), an application specific integrated circuit (ASIC), a Field-Programmable Gate Array (FPGA) or other programmable logic device, a discrete gate, or a transistor logic device, or a discrete hardware component, etc. The processor 32 may be a microprocessor or any conventional processor. The processor 32 may be a control center of the electronic device 3, and connect various parts of the entire electronic device 3 by using various interfaces and lines.

The storage device 31 may be configured to store the computer program 40 and/or modules/units. The processor 32 may run or execute the computer-readable instructions and/or modules/units stored in the storage device 31, and may invoke data stored in the storage device 31 to implement various functions of the electronic device 3. The storage device 31 may include a program storage area and a data storage area. The program storage area may store an operating system, an application program required for at least one function (such as a sound playback function, an image playback function), etc. The data storage area may store data (such as audio data, or a phone book) created for using the electronic device 3. In addition, the storage device 31 may include a random access memory, and may also include a non-transitory storage medium, such as a hard disk, an internal memory, a plug-in hard disk, a smart media card (SMC), and a secure digital (SD) card, a flash card, at least one disk storage device, a flash memory, etc.

With reference to FIG. 1, the storage device 31 in the electronic device 3 stores a plurality of instructions that are executed by the processor 32 to implement to an information push method including: acquiring a first facial image of a target user; extracting first expression features of the first facial image; determining a first emotion according to the first expression features; determining candidate advertising information according to the first emotion; obtaining historical emotions of the target user; determining target advertising information from the candidate advertising information according to the historical emotions; and pushing the target advertising information to the target user.

In one embodiment, a first method of determining target advertising information from the candidate advertising information according to the historical emotions includes: determining a target historical emotion according to the historical emotions; acquiring historical advertising information corresponding to the target historical emotion; determining product characteristics according to the historical advertising information; and determining the target advertising information that matches the product characteristics from the candidate advertising information.

In one embodiment, a method of acquiring a first facial image of a target user includes: obtaining a current image in real time; using a facial recognition technology to determine all registered users in the current image; determining whether there is a plurality of registered users in the current image; upon condition that there is one registered user in the current image, determining that the registered user is the target user; and determining the first facial image of the target user from the current image.

In one embodiment, the processor 32 can execute the instructions to implement: upon condition that there is a plurality of registered users in the current image, determining a usage time of each registered user in the current image; determining that a registered user with a longest usage time in the current image is the target user; and determining the first facial image of the target user from the current image.

In one embodiment, the processor 32 can execute the instructions to implement: receiving a user selection instruction if there is a plurality of registered users; determining a user indicated by the user selection instruction to be the target user; and determining the first facial image of the target user from the current image.

In one embodiment, after pushing the target advertising information to the target user, the processor 32 can execute the instructions to implement: acquiring a second facial image of the target user; extracting second expression features of the second facial image; determining a second emotion according to the second expression features; and adding the second emotion into the historical emotions of the target user.

The processor 32 executes the instructions to implement the information pushing method can refer to the description of the steps of FIG. 1, which will not be repeated here.

In the electronic device described in FIG. 3, a user's emotion can be determined using facial recognition technology. Proper advertising information is pushed to the user based on a current emotion and historical emotions. Effectiveness and timeliness of information pushing are improved.

When the modules/units integrated in the electronic device 3 are implemented in the form of software functional units and used as independent units, they can be stored in a non-transitory readable storage medium. Based on this understanding, all or part of the processes in the methods of the above embodiments implemented by the present disclosure can also be completed by related hardware instructed by computer-readable instructions. The computer-readable instructions may be stored in a non-transitory readable storage medium. The computer-readable instructions, when executed by the processor, may implement the steps of the foregoing method embodiments. The computer-readable instructions include computer-readable instruction codes, and the computer-readable instruction codes can be source code, object code, an executable file, or in some intermediate form. The non-transitory readable storage medium may include any entity or device capable of carrying the computer-readable instruction code, a recording medium, a U disk, a mobile hard disk, a magnetic disk, an optical disk, a computer memory, and a read-only memory (ROM).

In several embodiments provided in the preset application, it should be understood that the disclosed electronic device, system and method may be implemented in other ways. For example, the embodiment of the electronic device described above is merely illustrative. For example, the units are only obtained by logical function divisions, and there may be other manners of division in actual implementation.

The modules described as separate components may or may not be physically separated, and the components displayed as modules may or may not be physical units, that is, they may be located in one place, or may be distributed on multiple network units. Some or all of the modules may be selected according to actual needs to achieve the objectives of the solutions of the embodiments.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but do not signify any particular order.

Finally, the above embodiments are only used to illustrate technical solutions of the present disclosure, and are not to be taken as restrictions on the technical solutions. Although the present disclosure has been described in detail with reference to the above embodiments, those skilled in the art should understand that the technical solutions described in one embodiment can be modified, or some of technical features can be equivalently substituted, and that these modifications or substitutions are not to detract from the essence of the technical solutions or from the scope of the technical solutions of the embodiments of the present disclosure.

1. An information pushing method, comprising:
acquiring a first facial image of a target user;
extracting first expression features of the first facial image;
determining a first emotion according to the first expression features;
determining candidate advertising information according to the first emotion;
obtaining historical emotions of the target user;
determining target advertising information from the candidate advertising information according to the historical emotions; and
pushing the target advertising information to the target user.

2. The information pushing method of claim 1, wherein a method of determining target advertising information from the candidate advertising information according to the historical emotions comprises:
determining a target historical emotion according to the historical emotions;
acquiring historical advertising information corresponding to the target historical emotion;
determining product characteristics according to the historical advertising information; and
determining the target advertising information that matches the product characteristics from the candidate advertising information.

3. The information pushing method of claim 1, wherein a method of acquiring a first facial image of a target user comprises:
obtaining a current image in real time;
using a facial recognition technology to determine all registered users in the current image;
determining whether there is a plurality of registered users in the current image;
upon condition that there is one registered user in the current image, determining that the registered user is the target user; and
determining the first facial image of the target user from the current image.

4. The information pushing method of claim 3, further comprising:
upon condition that there is a plurality of registered users in the current image, determining a usage time of each registered user in the current image;
determining that a registered user with a longest usage time in the current image is the target user; and
determining the first facial image of the target user from the current image.

5. The information pushing method of claim 3, further comprising:
receiving a user selection instruction upon condition that there is a plurality of registered users;
determining a user indicated by the user selection instruction to be the target user; and
determining the first facial image of the target user from the current image.

6. The information pushing method of claim 1, after pushing the target advertising information to the target user, the method further comprising:
acquiring a second facial image of the target user;
extracting second expression features of the second facial image;
determining a second emotion according to the second expression features; and
adding the second emotion into the historical emotions of the target user.

7. An electronic device, comprising:
a processor; and
a storage device storing a plurality of instructions, which when executed by the processor, causes the processor to:
acquire a first facial image of a target user;
extract first expression features of the first facial image;
determine a first emotion according to the first expression features;
determine candidate advertising information according to the first emotion;
obtain historical emotions of the target user;
determine target advertising information from the candidate advertising information according to the historical emotions; and
push the target advertising information to the target user.

8. The electronic device of claim 7, wherein a method of determining target advertising information from the candidate advertising information according to the historical emotions comprises:
determining a target historical emotion according to the historical emotions;
acquiring historical advertising information corresponding to the target historical emotion;
determining product characteristics according to the historical advertising information; and
determining the target advertising information that matches the product characteristics from the candidate advertising information.

9. (canceled)

10. A non-transitory storage medium having stored thereon computer-readable instructions that, when executed by a processor of an electronic device, causes the processor to:
acquire a first facial image of a target user;
extract first expression features of the first facial image;
determine a first emotion according to the first expression features;
determine candidate advertising information according to the first emotion;
obtain historical emotions of the target user;
determine target advertising information from the candidate advertising information according to the historical emotions; and
push the target advertising information to the target user.

11. The electronic device of claim 7, wherein a method of acquiring a first facial image of a target user comprises:
obtaining a current image in real time;
using a facial recognition technology to determine all registered users in the current image;
determining whether there is a plurality of registered users in the current image;
upon condition that there is one registered user in the current image, determining that the registered user is the target user; and
determining the first facial image of the target user from the current image.

12. The electronic device claim 11, wherein the processor further:
upon condition that there is a plurality of registered users in the current image, determines a usage time of each registered user in the current image;
determines that a registered user with a longest usage time in the current image is the target user; and
determines the first facial image of the target user from the current image.

13. The electronic device of claim 11, wherein the processor further:
receives a user selection instruction upon condition that there is a plurality of registered users;
determines a user indicated by the user selection instruction to be the target user; and
determines the first facial image of the target user from the current image.

14. The information pushing method of claim 7, wherein after pushing the target advertising information to the target user, the processor further:
acquires a second facial image of the target user;
extracts second expression features of the second facial image;
determines a second emotion according to the second expression features; and
adds the second emotion into the historical emotions of the target user.

15. The non-transitory storage medium of claim 10, wherein a method of determining target advertising information from the candidate advertising information according to the historical emotions comprises:
determining a target historical emotion according to the historical emotions;
acquiring historical advertising information corresponding to the target historical emotion;
determining product characteristics according to the historical advertising information; and
determining the target advertising information that matches the product characteristics from the candidate advertising information.

16. The non-transitory storage medium of claim 10, wherein a method of acquiring a first facial image of a target user comprises:
obtaining a current image in real time;
using a facial recognition technology to determine all registered users in the current image;
determining whether there is a plurality of registered users in the current image;
upon condition that there is one registered user in the current image, determining that the registered user is the target user; and
determining the first facial image of the target user from the current image.

17. The non-transitory storage medium claim 16, wherein the processor further:
upon condition that there is a plurality of registered users in the current image, determines a usage time of each registered user in the current image;
determines that a registered user with a longest usage time in the current image is the target user; and
determines the first facial image of the target user from the current image.

18. The non-transitory storage medium of claim 16, wherein the processor further:
receives a user selection instruction upon condition that there is a plurality of registered users;
determines a user indicated by the user selection instruction to be the target user; and
determines the first facial image of the target user from the current image.

19. The non-transitory storage medium method of claim 10, wherein after pushing the target advertising information to the target user, the processor further:
acquires a second facial image of the target user;
extracts second expression features of the second facial image;
determines a second emotion according to the second expression features; and
adds the second emotion into the historical emotions of the target user.
